(19) United States
(12) Patent Application Publication
(10) Pub. No.: US 2007/0100071 A1
(43) Pub. Date: May 3, 2007

(54) Organic fibre based on an epoxy resin and a rheology-controlling agent and corresponding dry goods

(76) Inventors: Anthony Bonnet, Beaumont Le Roger (FR); Elisabeth Loerch, Brionne (FR); Laurent Gervat, Brassempouy (FR); Regis Cipriani, Tournedos Bois Hubert (FR); Francois Beaume, Bernay (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 10/580,371

(22) PCT Filed: Nov. 25, 2004
(86) PCT No.: PCT/FR04/03027

§ 371 Date: May 23, 2006

(30) Foreign Application Priority Data
Nov. 25, 2003 (FR) 0313805

(51) Int. Cl. C08L 53/00

(52) U.S. Cl. 525/88; 525/216

(57) ABSTRACT

The present invention relates to a formulation and to a process which make it possible to produce, using an epoxide resin and an agent for controlling the rheology, on the one hand, and reinforcing fibres, on the other hand, semi-finished products for composites in the form of jointly woven or knitted yarns which make it possible to prepare thermoset materials by simple heating.

The present invention relates to the field of composite materials based on reinforcing fibres and on thermoset resins, in particular to composite materials based on thermoset resins comprising a rheology-regulating agent, which exhibit a thermoplastic behaviour and which can be converted into yarns which can be woven or knitted.

A composite material according to the invention is composed of an organic matrix and of an inorganic or organic reinforcement which can be provided in the form of fibres or of textiles, it being possible for the organic matrix to be a thermoset material as is described below.

A thermoset material is defined as being formed of polymer chains of variable length bonded to one another via covalent bonds, so as to form a three-dimensional network. Thermoset materials can be obtained, for example, by reaction of a thermosetting resin, such as an epoxy, with a hardener of amine type. Thermoset materials exhibit numerous properties which allow them to be used as structural adhesives or as matrix for composite materials or in applications for protecting electronic components.

The reinforcing fibre, which can comprise several thousand filaments, improves the mechanical characteristics of the composite structure. It can be composed of glass, of carbon, of aramid or of any other organic or inorganic material introducing the desired characteristics.

The epoxy materials have a high crosslinking dentensity, which provides them with a high glass transition temperature (Tg), which confers excellent thermomechanical properties on the material. The higher the crosslinking density, the higher the Tg of the material and consequently the better the thermomechanical properties and the higher the operating temperature limit of the material. Nevertheless, it is highly problematic to use them as they are liquids before reaction, which makes them difficult to handle. The preparation of composite by the standard techniques exhibits difficulties, such as the control of stage B. This is because the process generally employed by a person skilled in the art involves a stage of wetting the fibres with the epoxy resin with a loss of material due to the drop phenomenon observed, a phenomenon directly related to the low cohesion of the liquid resin.

This wetting stage is followed by a precuring stage to bring the thermoset resin to an intermediate conversion, referred to as stage B, allowing easier handling. These various processes are described, for example, in the work by Maurice Reyne, “Technologie des composites” [Technology of Composites], published Hermes, 1998.

The Applicant Company has just found that specific formulations based on thermosetting materials and on rheology-regulating agents can be converted into filaments or slivers which can be woven or knitted in conjunction with organic or inorganic fibres. This makes it possible to obtain woven or knitted fabrics which can be handled with great ease and which can be subjected to a hot compression process in order to be formed and in order to make possible the reaction of the formulation of thermosetting materials and of rheology-regulating agents, resulting in the final composite material.

The formulations of the invention comprise a thermosetting resin and a block copolymer having at least one block miscible with the said resin, for example composed predominantly of methyl methacrylate units, used as an agent for controlling the rheology, and at least one immiscible block. These materials can be manufactured by dissolution of the copolymer in the thermosetting resin, followed by the addition of the hardener. This dissolution can, for example, be carried out by the extrusion technique. The extrusion technique also makes possible the production of filaments which can be converted into slivers. These slivers of formulations of liquid epoxide resins and of block copolymers exhibit a thermoplastic behaviour and are woven or knitted with reinforcing fibres.

The first subject-matter of the invention is an organic fibre composed of a thermosetting resin and of an agent for controlling the rheology which can be obtained by extrusion, for example starting from a formulation based on the thermosetting materials and on rheology-regulating agents.

Another subject-matter of the invention is a woven or knitted fabric obtained according to the following method:
a. Weaving or knitting the filaments or fibres of the invention with fibres made of glass or of carbon or of any other type of organic or inorganic material.
b. Producing the desired structures with the semi-finished product obtained in a according to standard techniques for processing semi-finished products or thermoset composites, such as moulding, including drape moulding, or producing sandwich systems.
c. Reaction of the formulation in order to obtain a composite material according to the standard techniques for processing thermoset composite materials, such as hot forming.

The formulation of the invention comprises:
from 10 to 99% by weight of the total weight of the formulation of at least one thermosetting resin (I),
from 1 to 80% by weight of the total weight of the formulation of a rheology-controlling agent (II) comprising, for example, at least one block copolymer chosen from copolymers comprising S-B-M, B-M and M-B-M blocks in which:
each block is connected to the other by means of a covalent bond or of one or more intermediate molecules connected to one of the blocks via a covalent bond and to the other block via another covalent bond,
M is a polymer miscible with the thermosetting resin, for example a methyl methacrylate homopolymer or a copolymer (obtained by the polymerization of a mixture of monomers comprising at least 50% by weight of methyl methacrylate) comprising at least 50% by weight of methyl methacrylate,
B is a polymer incompatible with the thermosetting resin and with the M block and its glass transition temperature (Tg) is lower than the operating temperature for the thermoset material,
S is a polymer incompatible with the thermosetting resin (I) and the B block and its Tg or its melting point (M.p.) is greater than the Tg of B,
from 0 to 50% by weight of the total weight of the formulation of at least one material (III) chosen from thermoplastics, core-shell additives, functionalized elastomers, S-B copolymers and ATBN or CTBN reactive rubbers.

The formulation of the invention exhibits a thermoplastic behaviour and can be processed by the standard techniques for the conversion of thermoplastic materials but having the property of reacting to form a thermoset material. This formulation can, during the reaction, occur in a fully liquid or rubbery state.

As regards the thermoset material, it is defined as being formed of polymer chains of variable length bonded to one another via covalent bonds, so as to form a three-dimensional network.

Mention may be made, as examples, of cyanoacrylates, bismaleimides and epoxy resins crosslinked by a hardener.

Mention may be made, among cyanoacrylates, of cyanoacrylic esters, which are thermoset materials obtained by polymerization of the monomer CH₂═C(CN)COOR with various possible R groups (without requiring addition of a hardener).

The thermosetting formulations of bismaleimide type are, for example: methylenedianiline+benzophenone dianhydride+nadic imide methylenedianiline+benzophenone dianhydride+phenylacetylene methylenedianiline+maleic anhydride+maleimide.

The thermoset material advantageously results from the reaction of a thermosetting epoxy resin and of a hardener. It is also defined as any product of the reaction of an oligomer carrying oxirane function groups and of a hardener. The reactions which occur during the reaction of these epoxy resins result in a crosslinked material corresponding to a three-dimensional network which is more or less dense according to the fundamental characteristics of the resins and hardeners employed.

The term “epoxy resin”, hereinafter denoted by E, is understood to mean any organic compound having at least two functional groups of oxirane type which can be polymerized by ring opening. The term “epoxy resins” denotes any conventional epoxy resin which is liquid at ambient temperature (23° C.) or at a higher temperature. These epoxy resins can be monomeric or polymeric, on the one hand, aliphatic, cycloaliphatic, heterocyclic or aromatic, on the other hand. Mention may be made, as examples of such epoxy resins, of resorcinol diglycidyl ether, bisphenol A diglycidyl ether, triglycidyl-p-aminophenol, bromobisphenol F diglycidyl ether, m-aminophenol triglycidyl ether, tetraglycidylmethylenedianiline, (trihydroxyphenyl)methane triglycidyl ether, polyglycidyl ethers of phenol-formaldehyde novolak, polyglycidyl ethers of ortho-cresol novolak and tetraglycidyl ethers of tetraphenylethane. Mixtures of at least two of these resins can also be used.

Epoxy resins having at least 1.5 oxirane functional groups per molecule and more particularly epoxy resins comprising between 2 and 4 oxirane functional groups per molecule are preferred. Epoxy resins having at least one aromatic ring, such as bisphenol A diglycidyl ethers, are also preferred.

As regards the hardener, use is generally made, as hardeners, of hardeners for epoxy resins which react at ambient temperature or at temperatures greater than ambient temperature. Mention may be made, as nonlimiting examples, of:
acid anhydrides, including succinic anhydride,
aromatic or aliphatic polyamines, including diaminodiphenyl sulphone (DDS) or methylenedianiline or 4,4′-methylenebis(3-chloro-2,6-diethylaniline) (MCDEA),
dicyandiamide and its derivatives,
imidazoles,
polycarboxylic acids,
polyphenols.

The term “rheology control agent” is understood to mean a compound which, blended with the thermosetting material, makes it possible for the latter to be able to be converted by any technique for the processing of thermoplastics while retaining the property of reacting to form a thermoset material. The choice will advantageously be made of a block copolymer chosen from S-B-M, B-M or M-B-M block copolymers in which:
each block is connected to the other by means of a covalent bond or of one or more intermediate molecules connected to one of the blocks via a covalent bond and to the other block via another covalent bond,
M is a polymer which is miscible with the thermosetting resin. Preferably, M is composed of methyl methacrylate monomers or comprises at least 20% by weight of methyl methacrylate, preferably at least 50% by weight of methyl methacrylate. The other monomers constituting the M block may or may not be acrylic monomers and may or may not be reactive. The term “reactive monomer” is understood to mean: a chemical group capable of reacting with the oxirane functional groups of the epoxy molecules or with the chemical groups of the hardener. Mention may be made, as nonlimiting examples of reactive functional groups, of: oxirane functional groups, amine functional groups or carboxyl functional groups. The reactive monomer can be (meth)acrylic acid or any other hydrolysable monomer resulting in these acids. Mention may be made, among the other monomers which can constitute the M block, as nonlimiting examples, of glycidyl methacrylate or tert-butyl methacrylate. For certain applications requiring a high operating temperature for the composite material, it is preferable to use an M block composed predominantly of syndiotactic PMMA, to at least 75%, which makes it possible to obtain a PMMA block of the copolymer with a high Tg and thus to retain a high operating temperature for the composite material.
Advantageously, the Tg of B is less than 0° C. and preferably less than −40° C. The monomer used to synthesize the elastomeric B block can be a diene chosen from butadiene, isoprene, 2,3-dimethyl-1,3-butadiene, 1,3-pentadiene or 2-phenyl-1,3-butadiene. B is advantageously chosen from poly(dienes), in particular poly(butadiene), poly(isoprene) and their random copolymers, or from partly or completely hydrogenated poly(dienes). Use is advantageously made, among polybutadienes, of those with the lowest Tg, for example 1,4-polybutadiene with a Tg (approximately −90° C.) lower than that of 1,2-polybutadiene (approximately 0° C.). The B blocks can also be hydrogenated. This hydrogenation is carried out according to the standard techniques. The monomer used to synthesize the elastomeric B block can also be an alkyl (meth)acrylate. The corresponding Tg values are shown between brackets after the monomer used: ethyl acrylate (−24° C.), butyl acrylate (−45° C.), 2-ethylhexyl acrylate (−60° C.), hydroxyethyl acrylate (−15° C.) and 2-ethylhexyl methacrylate (−10° C.). Butyl acrylate is advantageously used. The acrylates of B are different from those of the M block in order to observe the condition that B and M are incompatible. Preferably, the B blocks are composed predominantly of 1,4-polybutadiene. B is incompatible with the thermosetting resin and with the M block and its glass transition temperature Tg is lower than the operating temperature for the thermoset material,
S is incompatible with the thermosetting resin and the B block and its Tg or its melting point M.p. is greater than the Tg of B. The Tg or the M.p. of S is advantageously greater than 23° C. and preferably greater than 50° C. Mention may be made, as examples of S blocks, of those which derive from vinylaromatic compounds, such as styrene, α-methylstyrene or vinyltoluene, and those which derive from alkyl esters of acrylic acid and/or methacrylic acid having from 1 to 18 carbon atoms in the alkyl chain.

The S-B-M, B-M or M-B-M copolymer has a weight-average molar mass which can be between 10 000 g/mol and 500 000 g/mol, preferably between 20 000 and 200 000 g/mol. Advantageously, expressed as fraction by weight, the total of which is 100%, its composition will be:

For M: between 10 and 80% and preferably between 15 and 70%.

For B: between 2 and 80% and preferably between 5 and 70%.

For S: between 10 and 88% and preferably between 15 and 85%.

The block copolymers used in the composition of the present invention can be manufactured, for example, by anionic polymerization according to the processes disclosed in Patent Applications EP 524.054 and EP 749 987 or by controlled radical polymerization.

The proportion of rheology control agent is advantageously from 10 to 60% for respectively 90 to 40% of thermoset resin.

According to preferred form of the invention, the rheology control agent comprises at least one S-B-M block copolymer and at least one S-B block copolymer. It advantageously comprises between 5 and 80% of S-B diblock for respectively from 95 to 20% of S-B-M triblock.

As regards the S-B diblock, the S and B blocks are incompatible and they are composed of the same monomers and optionally comonomers as the S blocks and the B blocks of the S-B-M triblock. The S and B blocks can be identical to or different from the other S and B blocks present in the other block copolymers of the impact modifier in the thermoset material.

The S-B diblock has a weight-average molar mass which can be between 10 000 g/mol and 500 000 g/mol, preferably between 20 000 and 200 000 g/mol. The S-B diblock is advantageously composed of a fraction by weight of B of between 5 and 95% and preferably between 5 and 60%.

Furthermore, the advantage of these compositions is that it is not necessary to purify the S-B-M on conclusion of its synthesis. This is because the S-B-M copolymers are generally prepared from the S and B copolymers and the reaction often results in a blend of S-B and S-B-M copolymers which is subsequently separated to have available S-B-M copolymer.

According to an advantageous form, a portion of the S-B-M can be replaced by an S-B diblock. This portion can be up to 70% by weight of the S-B-M.

It would not be departing from the scope of the invention to replace all or a portion of the S-B-M triblock by an M-S-B-S-M or M-B-S-B-M pentablock. They can be prepared by anionic polymerization, like the di- or tri-blocks mentioned above, for using a difunctional initiator. The number-average molar mass of these pentablocks is within the same ranges as that of the S-B-M triblocks. The proportion of the two M blocks together or of the two B or S blocks together is within the same ranges as the proportions of S, B and M in the S-B-M triblock.

The formulations of the invention can be prepared by blending the thermoset resin, not yet crosslinked, using a conventional blending device. Use may be made of any thermoplastic technique which makes it possible to prepare a homogeneous blend between the thermosetting resin and the control agent, such as extrusion. The product obtained will be provided in the filament or sliver form. The unreacted or partially reacted material thus obtained can thus exist in the form of a handleable rubbery material. This processing will be carried out at a temperature where the reaction kinetics of the thermosetting material are slow. In stage [c], during the processing in the form of finished object and by simple increase in the temperature, the thermosetting resin will be converted into a thermoset material. During the increase in temperature, the rubbery material in the course of reaction can, according to the nature of the resin (II) and of the agent (I) used, return to liquid state or remain in the rubbery state.

It is obvious that this invention can be applied to a reactive liquid resin which can form, after reaction, a linear or branched polymer exhibiting a thermo plastic behaviour. This step can be successfully applied, for example, to acrylic resins without departing from the scope of the invention.

The finished objects of the invention can be used in various applications, such as in the sports, industrial, motor vehicle, electronics and aeronautical fields.

Curing Conditions:

These are the standard conditions.

It would not be departing from the scope of the invention to add the standard additives to the formulation, such as thermoplastics, for example polyethersulphones, polysulphones, polyetherimides or polyphenylene ethers, liquid elastomers or impact modifiers of core-shell type.

The following examples illustrate the invention without limiting the scope thereof.

The following products were used:

Epoxy resin: it is a bisphenol A diglycidyl ether (BADGE) with a molar mass of 383 g/mol, with a mean number of hydroxyl groups per one epoxy group of n=0.075, sold by Vantico under the commercial reference LY556.

Hardener: it is an amine hardener which is an aromatic diamine, 4,4′-methylenebis-(3-chloro-2,6-diethylaniline), sold by Lonza under the commercial reference Lonzacure M-DEA. This product is characterized by a melting point of between 87° C. and 90° C. and a molar mass of 310 g/mol.

SBM1: it is an S-B-M triblock copolymer in which S is polystyrene, B is polybutadiene and M is poly(methyl methacrylate). SBM1 comprises 22% as fraction by weight of polystyrene, 9% as fraction by weight of polybutadiene and 69% by weight of poly(methyl methacrylate), obtained by anionic polymerization successively of a polystyrene block with a weight-average molar mass of 7000 g/mol, of a polybutadiene block with a weight-average molar mass of 11 000 g/mol and of a poly(methyl methacrylate) block with a weight-average molar mass of 84 000 g/mol. This product was prepared according to the procedure disclosed in EP 524-054 and in EP 749-987. This product exhibits three glass transitions, one at −90° C., another at 95° C. and a third at 130° C.

SBM2: it is an S-B-M triblock copolymer in which S is polystyrene, B is polybutadiene and M is PMMA comprising 12% as fraction by weight of polystyrene, 18% as fraction by weight of polybutadiene and 70% by weight of poly(methyl methacrylate), obtained by anionic polymerization successively of a polystyrene block with a weight-average molar mass of 14 000 g/mol, of a polybutadiene block with a weight-average molar mass of 22 000 g/mol and of a poly(methyl methacrylate) block with a weight-average molar mass of 85 000 g/mol. This product was prepared according to the procedure disclosed in EP 524-054 and in EP 749-987. This product exhibits three glass transitions, one at −90° C., another at 95° C. and a third at 130° C.

Curing Conditions:

The blends are cured at 220° C. for 2 hours.

Measurement of the Main Mechanical Relaxation Temperature, Tα, by Thermo Mechanical Analysis

Tα was measured by dynamic mechanical analysis on post-cured samples using a Rheometrics device (Rheometrics Solid Analyser RSAII). The samples, which are parallelepipedal in shape (1×2.5×34 mm³), are subjected to temperature scanning between 50 and 250° C. at a stress frequency of 1 Hz. The glass transition temperature is taken at the maximum of tan a.

### EXAMPLE 1

### ACCORDING TO THE INVENTION

An epoxide precursor, BADGE from Dow with a mass of 383 g/mol, is blended at stoichiometry with an amine hardener, MDEA. This blend is produced in a corotating twin-screw extruder of Werner 40 type with addition of 40% of SBM1. The lace obtained, exhibiting a diameter of 1 mm, is wound off at the extruder outlet. This lace is cowoven with a glass fibre from Owens Corning with a tex 1200 exhibiting a size of 121A-RX type. The glass to formulation ratio is 1.5. The cowoven product obtained can be easily handled and does not exhibit any drop phenomenon. The cowoven product obtained is placed under a press at 220° C. for 2 hours. After cooling, the Tg obtained is 165° C. and the Tα obtained is 172° C. The composite material obtained does not exhibit any swelling in toluene.

### EXAMPLE 2

### ACCORDING TO THE INVENTION

An epoxide precursor, BADGE from Dow with a mass of 383 g/mol, is blended at stoichiometry with an amine hardener, MDEA. This blend is produced in a corotating twin-screw extruder of Werner 40 type with addition of 40% of SBM2. The lace obtained, exhibiting a diameter of 1 mm, is wound off at the extruder outlet. This lace is cowoven with a glass fibre from Owens Corning with a tex 1200 exhibiting a size of 121A-RX type. The glass to formulation ratio is 1.5. The cowoven product obtained can be easily handled and does not exhibit any drop phenomenon. The cowoven product obtained is placed under a press at 220° C. for 2 hours. After cooling, the Tg obtained is 164.8° C. and the Tα obtained is 171.5° C. The composite material obtained does not exhibit any swelling in toluene.

### EXAMPLE 3

### COMPARATIVE

An epoxide precursor, BADGE from Dow with a mass of 383 g/mol, is blended at stoichiometry with an amine hardener, MDEA. This blend is produced in a corotating twin-screw extruder of Werner 40 type with addition of 40% of SBS finaclear 520 from Atofina. The material at the extruder outlet cannot be granulated as it does not exhibit any melt strength.

### EXAMPLE 4

### COMPARATIVE

An epoxide precursor, BADGE from Dow with a mass of 383 g/mol, is blended at stoichiometry with an amine hardener, MDEA. This blend is produced in a corotating twin-screw extruder of Werner 40 type with addition of 40% of D320 from Atofina. The material at the extruder outlet cannot be granulated as it does not exhibit any melt strength.

### EXAMPLE 5

### ACCORDING TO THE INVENTION

An epoxide precursor, BADGE from Dow with a mass of 383 g/mol, is blended at stoichiometry with an amine hardener, MDEA. This blend is produced in a corotating twin-screw extruder of Werner 40 type with addition of 40% of SBM2. The lace obtained, exhibiting a diameter of 1 mm, is wound off at the extruder outlet. This lace is woven in order to form a woven fabric made of SBM-BADGE-MDEA blend (blend A). This fabric is subsequently positioned over a glass fabric to form an A/glass fabric/A sandwich. This sandwich is subsequently placed in a press at 220° C. for 2 hours. After cooling, the Tg obtained is 164.8° C. and the Tα obtained is 171.4° C. The composite material obtained does not exhibit any swelling in toluene.

### EXAMPLE 6

An epoxide precursor, BADGE from Dow with a mass of 383 g/mol, is blended at stoichiometry with an amine hardener, MDEA. This blend is produced in a corotating twin-screw extruder of Werner 40 type with addition of 20% of SBM2. The lace obtained, exhibiting a diameter of 1 mm, is wound off at the extruder outlet. This lace is cowoven with a glass fibre from Owens Corning with a tex 1200 exhibiting a size of 121A-RX type. The glass to formulation ratio is 1.5. The cowoven product obtained can be easily handled and does not exhibit any drop phenomenon. The cowoven product obtained is placed under a press at 220° C. for 2 hours. After cooling, the Tg obtained is 164.8° C. and the Tα obtained is 171.7° C. The composite material obtained does not exhibit any swelling in toluene.

### EXAMPLE 7

An epoxide precursor, BADGE from Dow with a mass of 383 g/mol, is blended at stoichiometry with an amine hardener, MDEA. This blend is produced in a corotating twin-screw extruder of Werner 40 type with addition of 80% of SBM2. The lace obtained, exhibiting a diameter of 1 mm, is wound off at the extruder outlet. This lace is cowoven with a glass fibre from Owens Corning with a tex 1200 exhibiting a size of 121A-RX type. The glass to formulation ratio is 1.5. The cowoven product obtained can be easily handled and does not exhibit any drop phenomenon. The cowoven product obtained is placed under a press at 220° C. for 2 hours. After cooling, the Tg obtained is 164.8° C. and the Tα obtained is 160° C. The composite material obtained does not exhibit any swelling in toluene.

1. An Organic fibre exhibiting thermoplastic behavior comprising
from 10 to 99% by weight of the total weight of the formulation of at least one thermosetting resin,
from 1 to 80% by weight of the total weight of the formulation of a rheology-controlling agent comprising block copolymers selected from S-B-M, B-M M-B-M wherein:
the M blocks comprise a polymer miscible with said thermosetting resin,
the B blocks comprise a polymer incompatible with said thermosetting resin and incompatible with said M block having a glass transition temperature lower than the operating temperature for said thermosetting resin,
the S blocks comprise a polymer incompatible with said thermosetting resin and said B block and having a glass transition temperature greater than the glass transition temperature of B, and
from 0 to 50% by weight of the total weight of the formulation of at least one material chosen from thermoplastics, core-shell additives, functionalized elastomers, S-B copolymers, ATBN reactive rubbers or CTBN reactive rubbers.

2. Fibre according to claim 1, characterized in that the M block is chosen from poly(methyl methacrylate)s or copolymers comprising at least 20% by weight of methyl methacrylate.

3. Fibre according to claim 1, characterized in that the M blocks comprise at least 75% by weight syndiotactic PMMA.

4. Fibre according to claim 1, characterized in that the M blocks further comprise reactive monomers, selected from glycidyl methacrylate, tert-butyl methacrylate or acrylic acid.

5. Fibre according to claim 1, characterized in that the glass transition temperature of the B block is less than 0° C.

6. Fibre according to claim 5, characterized in that the B block is chosen from poly(alkyl acrylate)s, dienes or polydienes.

7. Fibre according to claim 6, characterized in that the B block is a 1,4-polybutadiene.

8. Fibre according to claim 5, characterized in that the dienes of the B block are hydrogenated.

9. Fibre according to claim 1, characterized in that the glass transition temperature of the S bock is greater than 23° C.

10. Fibre according to claim 9, characterized in that S block is chosen from methylstyrene, vinyltoluene or polystyrene.

11. Fibre according to claim 1, characterized in that the weight-average molar mass of the block copolymers is between 10 000 g/mol and 500 000 g/mol.

12. Fibre according to claim 11, characterized in that the weight-average molar mass of the block copolymers is between 20 000 g/mol and 200 000 g/mol.

13. Fibre according to claim 1, characterized in that the proportion of said rheology-controlling agent is from 10 to 60% when the proportion of said thermosettring resins is from 90 to 40%.

14. Fibre according to one of claims 1, characterized in that the thermosetting resin comprises a thermosetting epoxy resin and a hardener.

15-17. (canceled)

18. Fibre according to claim 1, characterized in that the glass transition temperature of the B block is less than 40° C.

19. Fibre according to claim 1, characterized in that said S block is chosen from vinylaromatics, or alkylesters of (meth)acrylic acid having 1 to 18 carbons in the alkyl chain.

20. Fibre according to claim 6, characterized in that the poly(alkyl acrylate)s is selected from poly(butyl acrylate), poly(ethylhexyl acrylate) or poly(octyl acrylate).

21. Fibre according to claim 1, characterized in that the glass transition temperature of the S block is greater than 50° C.

22. Fibre according to claim 1, characterized in that the proportion of said rheology-controlling agent is from 20 to 50% when the proportion of said thermosettring resins is from 80 to 50%.

23. The fibre of claim 1 formed via extrusion.

24. A process for forming a composite material comprising
combining a fibre of claim 1 with an organic or inorganic reinforcing fibre to form a fabric, and
reacting the fabric under hot pressure to form a composite material comprising a thermoset matrix.

25. The process of claim 24, characterized in that said organic or inorganic reinforcing fibre is selected from glass fibres, aramid fibres or carbon fibres.

26. The process of claim 24, characterized in that said combining comprising knitting.

27. The process of claim 24, characterized in that said combining comprising weaving.
